(19) United States
(12) Patent Application Publication
(10) Pub. No.: US 2025/0257674 A1
(43) Pub. Date: Aug. 14, 2025

(54) INTERNAL COMBUSTION ENGINE AND DIAGNOSTIC METHOD FOR CRANKCASE VENTILATION SYSTEM

(71) Applicant: Volkswagen Aktiengesellschaft, Wolfsburg (DE)

(72) Inventors: Mathias HAUPTVOGEL, Weferlingen (DE); Thomas HEIN, Quedlinburg (DE); Daniel OTTO, Wolfsburg (DE); Stephan WASSMANN, Isenbuettel (DE); Peter SCHUERMANN, Sassenburg (DE); Andre BADSTUEBNER, Kirchberg (DE)

(73) Assignee: Volkswagen Aktiengesellschaft, Wolfsburg (DE)

(21) Appl. No.: 19/050,044

(22) Filed: Feb. 10, 2025

(30) Foreign Application Priority Data
Feb. 8, 2024 (DE) 10 2024 201 150.9

(51) Int. Cl. F01M 13/02; F02M 25/06

(52) U.S. Cl. CPC F01M 13/021; F02M 25/06; F01M 2013/027

(57) ABSTRACT

An internal combustion engine with a crankcase ventilation system is provided, which, comprises a crankcase, an air intake line. The air intake line comprises a throttle valve and an air filter, and a crankcase ventilation line for venting the crankcase and a crankcase aeration line for flushing the crankcase. The crankcase ventilation line is arranged at a first junction downstream of the air filter at the air intake line. The crankcase aeration line, a sensor unit is arranged downstream of a first flow control device and upstream of a first backflow prevention device. The first junction is arranged downstream at a distance from a crankcase aeration line connection at the air intake line so that a malfunction of the crankcase ventilation system can be detected by the sensor unit.

This nonprovisional application claims priority under 35 U.S.C. § 119(a) to German Patent Application No. 10 2024 201 150.9, which was filed in Germany on Feb. 8, 2024, and which is herein incorporated by reference.

### BACKGROUND OF THE INVENTION

### Field of the Invention

The invention relates to an internal combustion engine which has a crankcase ventilation system and a crankcase aeration system, wherein these can be checked for their proper functioning. If an improper state is detected, an action is triggered.

### Description of the Background Art

Internal combustion engines that are designed as reciprocating engines have a piston with one or more piston rings due to their design. This piston is connected to a crankshaft via a connecting rod. The piston itself runs up and down in the combustion chamber, i.e., the cylinder. The cylinder and crankshaft are enclosed in a crankcase. During the combustion process, combustion gases are released from the combustion chamber into the crankcase due to the gap between the piston rings and the cylinder and the pressure gradient in the combustion chamber towards the crankcase. The escape of these combustion gases from the crankcase is prohibited by law in most countries around the world, as these combustion gases contribute to air pollution. Most legislation also requires that the integrity of the crankcase ventilation system be checked at regular intervals. “Regular” is often understood to mean that a check is carried out for typically occurring operating modes. To prevent the combustion gases from being released from the crankcase, the crankcase is flushed with fresh air. Fresh air is passed through the crankcase, where it mixes with the combustion gases. This mixture of combustion gas and fresh air is led through the crankcase ventilation line to the air intake line. There, the mixture mixes with the air in the air intake line and is thus fed into the combustion chamber so that the combustion gases are burned there. It is therefore important to ensure that the crankcase is always safely flushed and that both the crankcase and the crankcase ventilation line are intact. If there is a malfunction or improper state of the crankcase, crankcase ventilation line or crankcase aeration line, combustion gases can be released into the environment. Monitoring the integrity of the crankcase ventilation system, formed of the crankcase ventilation line and the crankcase aeration line, is therefore required. The monitoring covers the crankcase ventilation line, its connection to the air intake line, any backflow prevention devices located there, and the tightness of the crankcase ventilation line itself. The same applies to the crankcase aeration line and the crankcase itself.

DE 10 2009 008 831 A1 relates to an internal combustion engine with an air intake line containing an exhaust gas turbocharger compressor and a throttle valve, as well as with a tank ventilation system and a crankcase ventilation system, which are connected to the air intake line at two junctions in front of the compressor and behind the throttle valve. In order to enable monitoring of the discharge points of the vent gases into the air intake line in a relatively simple manner, it is proposed that a check valve be located directly at each junction. A separate crankcase aeration line, which only serves to aerate the crankcase, can be provided.

### SUMMARY OF THE INVENTION

It is therefore an object of the present invention to provide a device and a method by means of which the integrity of the crankcase ventilation system can be diagnosed more robustly and reliably.

To achieve the object, an internal combustion engine is proposed with a crankcase ventilation system, comprising a crankcase, an air intake line, wherein the air intake line comprises a throttle valve and an air filter, and a crankcase ventilation line for venting the crankcase and a crankcase aeration line for flushing the crankcase, the crankcase ventilation line being arranged at least at one first junction downstream of the air filter on the air intake line, characterized in that, wherein in the crankcase aeration line, a sensor unit is arranged downstream of a first flow control device and upstream of a first backflow prevention device, wherein the first junction is spaced downstream of a crankcase ventilation line connection at the air intake line, so that a malfunction of the crankcase ventilation system can be detected by the sensor unit.

The proposed internal combustion engine allows for operation in the uncharged state and, in its further developments, in the charged state. The internal combustion engine thus forms the basis for its further developments. The proposed internal combustion engine allows for the integrity of the crankcase ventilation system to be reliably diagnosed using a probe in the crankcase ventilation system. Furthermore, the proposed internal combustion engine allows for a crankcase aeration line that serves solely to aerate the crankcase. In a proper state, the probe will therefore never be exposed to combustion gases. This means that the probe is not exposed to a corrosive environment and can therefore be made of less demanding materials. This means that if the crankcase aeration line leaks, no combustion gas escapes into the environment. Due to the placement of the probe in the crankcase aeration line, it has proven to be advantageous that the probe is not exposed to elevated temperatures, so that it can be made of less demanding materials. Furthermore, compensation for temperature fluctuation is necessary to a lesser extent than if it were flushed with combustion gases.

In an example, a turbocharger can be located in the internal combustion engine downstream of the first junction and upstream of the throttle valve.

The arrangement of a turbocharger can enable such a charged state. As a function of the driving mode, operation can take place in a charged or uncharged state. This means that the internal combustion engine can have several states to choose from. The integrity of the crankcase ventilation system can be diagnosed in all of these modes.

The turbocharger and the throttle valve can be arranged in the internal combustion engine between the first junction and a second junction, wherein the second junction is located at the air intake line.

This arrangement allows for the integrity of the crankcase ventilation system to be robustly verified. The arrangement of the turbocharger and the throttle valve between the first and second junctions creates a vacuum in the air intake line downstream of the throttle valve. Due to this vacuum, the combustion gases are fed through the crankcase ventilation line from the crankcase to the air intake line and fed into the combustion chamber.

A backflow prevention device can be arranged upstream of the respective junctions of the crankcase ventilation line to the air intake line.

The backflow prevention devices can provide targeted diagnosis in an uncharged state and in a charged state. As a function of the state of the internal combustion engine, it can be determined which of the backflow prevention devices is not working properly. Furthermore, the integrity of the crankcase aeration line can be determined as a function of the operating mode.

In an example of the internal combustion engine, in which the crankcase ventilation line includes a crankcase ventilation line branching and a pressure control unit, the pressure control unit can be located upstream of the crankcase ventilation line branching.

It has been shown to be advantageous for a pressure control unit to be located in the crankcase ventilation line upstream of the crankcase ventilation line branching. This pressure control unit can configured to set a vacuum in the crankcase. This vacuum can be adjusted so that sufficient combustion gases are discharged from the crankcase without an excess of combustion gas being sucked out of the combustion chamber past the piston rings into the crankcase due to the pressure gradient in the crankcase. This can increase the motor efficiency and reduce the load on the oil separator. Furthermore, the quantity of combustion gases that supply unburned and partially burned fuel and thus calorific value, which is not taken into account in the injection quantity, into the air intake line can be limited. This allows for the internal combustion engine to operate more evenly.

The pressure control unit can be configured to set a volume flow from the crankcase into the intake line, so that a specified vacuum in the crankcase is achieved in the best possible way.

Adjusting the flow rate to a specified vacuum in the intake line can allow for better adaptation to the quantity of combustion gases to be discharged from the crankcase. This allows for the internal combustion engine to be operated more efficiently. By adapting the vacuum to the flow rate in the intake line, the crankcase ventilation line can also be designed to suit requirements. This can offer advantages in terms of material usage and pressure loss in the crankcase ventilation line, the first line and the second line.

The pressure control unit can include an adjustment function and is connected to a computer unit for specifying a pressure to be set.

Due to the adjustment function of the pressure control unit, the pressure in the first line and in the second line as well as in the crankcase and the crankcase ventilation line can be specifically adjusted. This allows for the combustion gases to be introduced at the pressure level of the air intake line in relation to the respective junction and the respective operating mode. The diagnosis of the operating mode can be more robust by such an adjustment of the pressure level in the crankcase ventilation line, the first line and the second line. The use of a computer unit can allow for the recording of the specified pressures to the pressure control unit. Moreover, it can collect the data from the sensor unit. Furthermore, the computer unit can be connected to the sensor unit and can record its signals. The computer unit can also be connected at least to the control unit of the internal combustion engine. By recording the operating mode, the signal from the sensor and, if applicable, the specified and/or actual pressure of the pressure control unit in the crankcase ventilation line, the computer unit can determine a proper or improper state. In other words, a diagnosis of the crankcase ventilation system can be performed. The computer unit can record the operating mode, the signal from the sensor unit and the specified pressure with a time assignment and store it in a memory. This means that a diagnosis can be made later if this was not possible at the actual time. At the same time, this can trigger an action.

It has proven to be advantageous that the pressure specified by the computer unit is a function of the operating point.

The specification of an operating point-dependent pressure in the crankcase ventilation line and thus in the crankcase can enable robust diagnostics for any operating mode of the internal combustion engine. Furthermore, the pressure in the crankcase ventilation line and the crankcase, specified as a function of the operating point, can limit the quantity of combustion gases that escape from the combustion chamber past the piston rings into the crankcase. This can increase the efficiency of the internal combustion engine. Furthermore, this can limit the quantity of combustion gases supplied to the intake air, which allows for the internal combustion engine to operate more evenly.

To achieve the object, a method for operating an internal combustion engine, comprising the following steps, can also be used. The steps do not necessarily have to be taken in the order listed. The following steps are performed: Detecting an operating mode, Detecting a signal from the sensor unit, Determining a specified reference value, Determining a difference between the detected signal from the sensor unit and the specified reference value, Determining whether the determined difference exceeds or falls below a specified value, Determining the state due to the exceeding or falling below the specified value, Triggering at least one action in accordance with the determined state.

The operating mode can be detected at the same time as the signal from the sensor unit is detected. The operating mode can take be detected with a time delay when the signal from the sensor unit is detected. As long as the intervals between two detections are sufficiently short, a time-delayed detection can be carried out without any problems. The comparison of the operating mode, the detection of a signal from the sensor unit, the determination of a specified reference value, the determination of a difference between the detected signal from the sensor unit and the specified reference value can be carried out in direct temporal proximity to the detection or at a time interval. If there is to be a time interval, then the values to be used for the method can be stored in a memory, which the computer unit can access. The method can be used to determine the state of the crankcase ventilation system. This state can be proper or improper. An improper state triggers an action. A proper state does not trigger any action. In particular, it can be determined whether a backflow prevention device is not working properly or whether a connection of the crankcase aeration line or the crankcase ventilation line to the air intake line is not working properly.

As a solution, a method for operating the internal combustion engine as described above is proposed. In this method, it can be determined whether the backflow prevention devices remain in the closed position during suction operation, characterized in that D_{S-V} corresponds to or substantially corresponds to or deviates from the permissible reference value D_{Z}.

This method can be used to determine that combustion gases are not being properly discharged from the crankcase. It can also be determined whether a backflow prevention device located in the crankcase ventilation line or in the crankcase aeration line is in a proper or improper state.

A motor vehicle with an internal combustion engine as described above and operated in accordance with the abovementioned method may be operated in such a way that in the event of a breach of the integrity of the crankcase ventilation system, in other words an improper state, there is an early prevention of polluting and non-compliant emissions.

This disclosure considers the entirety of the crankcase ventilation line and the crankcase aeration line and their respective connections to the crankcase as a crankcase ventilation system.

In the context of this disclosure, an internal combustion engine is understood to be an internal combustion engine based on the reciprocating piston principle, which can be ignited by spark ignition and/or spontaneous ignition. Fuel can be supplied to the internal combustion engine either by an external and/or an internal mixture formation. In an example, it is provided that the internal combustion engine can be operated in an uncharged state. In another example, it is provided that, if a turbocharger is present, the internal combustion engine can be operated in a charged state. An uncharged state exists when the pressure in the air intake line downstream of the throttle valve is equal to the ambient pressure or is below the ambient pressure. A charged state exists when the pressure in the air intake line downstream of the second pressure flow limiting device is above the ambient pressure.

As part of this disclosure, the crankcase aeration line can connect the air intake line to the crankcase. The crankcase aeration line can supply fresh air to the crankcase. It is also understood that the crankcase ventilation line can connect the crankcase to the air intake line. The crankcase ventilation line feeds the combustion gases that are mixed with the fresh air supplied to the crankcase via the crankcase aeration line to the air intake line. For the sake of simplicity, this mixture of combustion gases and fresh air is called combustion gases.

It is evident that a backflow prevention device may be, for example, either a check valve, in particular a diaphragm check valve, or a ball check valve with or without a return device, such as a spring, a flap valve, or a valve with an actuator monitored by an appropriately arranged measuring device and controlled by that measuring device. Other types of backflow prevention devices are possible.

It is understood in the context of this disclosure that a flow, or in the plural, flows, are to be understood as those gas flows which are passed through the air intake line, the crankcase aeration line, and the crankcase ventilation line. This flow or these flows can be either volume flows or mass flows. The direction of flow in the air intake line is considered to lead to the combustion chamber. The direction of flow in the crankcase aeration line is considered to lead to the crankcase. The direction of flow in the crankcase ventilation line is considered to be leading away from the crankcase and thus leading to the air intake line. In the context of this disclosure, it is defined that leading toward is synonymous with downstream. Upstream is therefore synonymous with leading away from.

It is provided that the integrity of the crankcase ventilation line can be checked. In other words, a state is determined. This state can be proper, i.e., with integrity, or improper, i.e., without integrity. This includes, in particular, the proper functioning of the backflow prevention devices, the presence of holes and/or cracks in the crankcase ventilation line and the proper connection of the crankcase ventilation line to the oil separator and/or the air intake line and/or to the backflow prevention devices and/or the pressure control unit and/or the crankcase ventilation line branching.

For the purposes of this disclosure, a proper state of the crankcase ventilation system may be understood to mean that all lines of the crankcase ventilation system are correctly connected and tight at their respective junctions. This means that there are no leaks at the junctions, in the lines themselves or at the junctions between line and fitting. It is also understood that all backflow prevention devices are working correctly. This means that the backflow prevention devices do not remain in one position, either completely or partially. In other words, the backflow prevention devices are not jammed.

In this disclosure, improper refers to the non-occurrence of proper. In other words, any state in which no proper state exists or has been determined is deemed improper.

It has been shown to be advantageous that a sensor unit in the crankcase aeration line generates a signal that is compared to a reference value. The signal itself reflects a value. This value denotes a flow property. From the comparison between the value and the reference value, the state of the crankcase ventilation line and/or the crankcase aeration line is concluded. In other words, a breach of the integrity of the crankcase ventilation line and/or the crankcase aeration line is determined.

The location of the sensor unit in the crankcase aeration line is advantageous because it significantly reduces the contamination of the sensor unit as compared to being arranged in the crankcase ventilation line, and the flow circulating around the sensor unit can be less corrosive than if the sensor unit were arranged in the crankcase ventilation line. Arranging the sensor unit in the crankcase aeration line is particularly advantageous as it allows for the integrity of the entire crankcase ventilation line to be checked with just one sensor. It is understood that this also includes the backflow prevention devices located in the crankcase ventilation line and the pressure control unit. The arrangement of the sensor unit in the crankcase aeration line allows for the integrity of the crankcase aeration line to be diagnosed.

An example of comparing the value of the signal from the sensor unit with the reference value can be a difference between the two values. In the context of this disclosure, it is specified that the value of the signal from the sensor unit is denoted as w_{S}, the reference value as w_{V} and the determined difference as D_{S-V}. It is also specified that in an example the difference D_{S-V} is determined by means of subtraction with the measured value w_{S} as minuend and the reference value w_{V} as subtrahend and when using this method is denoted by the difference D_{S-V}. In other words: D_{S-V}=w_{S}−w_{V}.

It is also specified that a permissible deviation of the difference D_{S-V} is referred to as D_{Z}. The permissible deviation D_{Z} is determined as a function of the operating point. The permissible deviation D_{Z} can be calculated as a function of the operating point relative to the reference value of the operating point. The permissible deviation D_{Z} can be specified in the form of an absolute to the respective operating point. A catalog can be used to determine the dependency of the operating point. The catalog can include a single value. A function can be used to determine the dependency of the operating point. The permissible deviation D_{Z} can also be specified as a fixed value, relative and absolute.

It is also understood that the reference value wᵥ can be a specified value or measured by a measuring device. The reference value may be a function of the operating point. Further, the specified reference value may not be a function of the operating point. This can be advantageous because it can increase the availability of reference values if the specified or measured value is not available.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an example of an arrangement of an internal combustion engine with a junction of the crankcase aeration line at the air intake line,

FIG. 2 shows an example of an internal combustion engine,

FIG. 3 shows an example of an internal combustion engine,

FIG. 4 shows an example of an internal combustion engine,

FIG. 5 shows an example of an internal combustion engine, and

FIG. 6 shows an exemplary sequence of the method.

### DETAILED DESCRIPTION

The combustion engine is shown strongly schematized by the crankcase 17 and the combustion chamber 31. Those skilled in the art will clearly understand the structure of an internal combustion engine with a reciprocating engine.

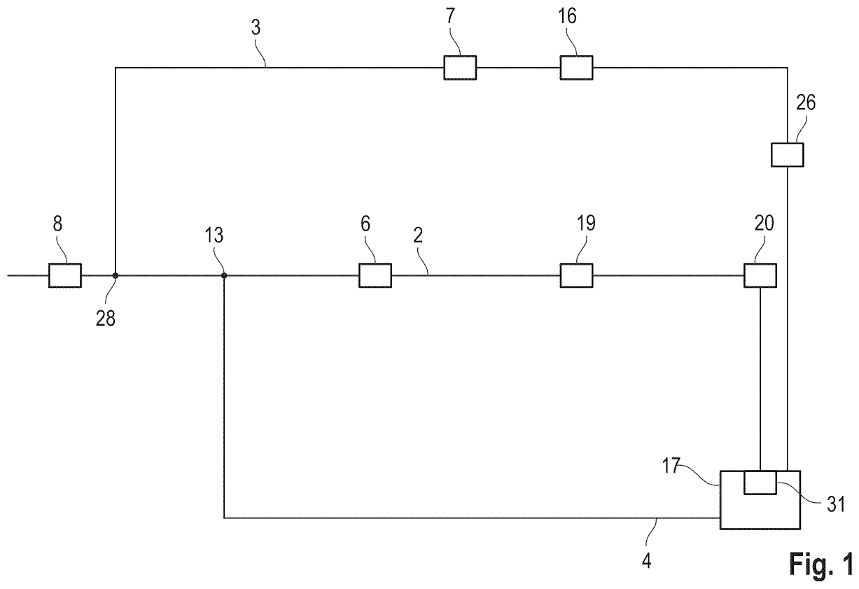

FIG. 1 shows an arrangement with a junction of the crankcase aeration line 3 to the air intake line 2. An internal combustion engine 1 without turbocharger 5 is shown. It is provided that the connection of the crankcase ventilation line 4 to the air intake line 2 is located between the throttle valve 6 and the connection of the crankcase aeration line 3 at the first junction 13 to the air intake line 2. In the air intake line 2, an air intake line branching 20 is arranged downstream of the throttle valve 6. Furthermore, an intercooler 19 may be located between throttle valve 6 and air intake line branching 20. It is provided to connect the crankcase aeration line 3 to the air intake line 2 at the crankcase aeration line connection 28 between the air filter 8 and the first junction 13. Further, the crankcase aeration line 3 is connected to the crankcase 17. In particular, it is provided that the first junction 13 of the crankcase aeration line 3 and the crankcase aeration line connection 28 are spaced apart. Furthermore, it is provided that at least one first backflow prevention device 26 and/or at least one first flow control device 7 is located upstream of the sensor unit 18 in the crankcase aeration line 3. This makes it possible to diagnose a breach of the integrity of the crankcase aeration line 3, in particular the first backflow prevention device 26, and/or the first flow limiting device 7 in suction mode.

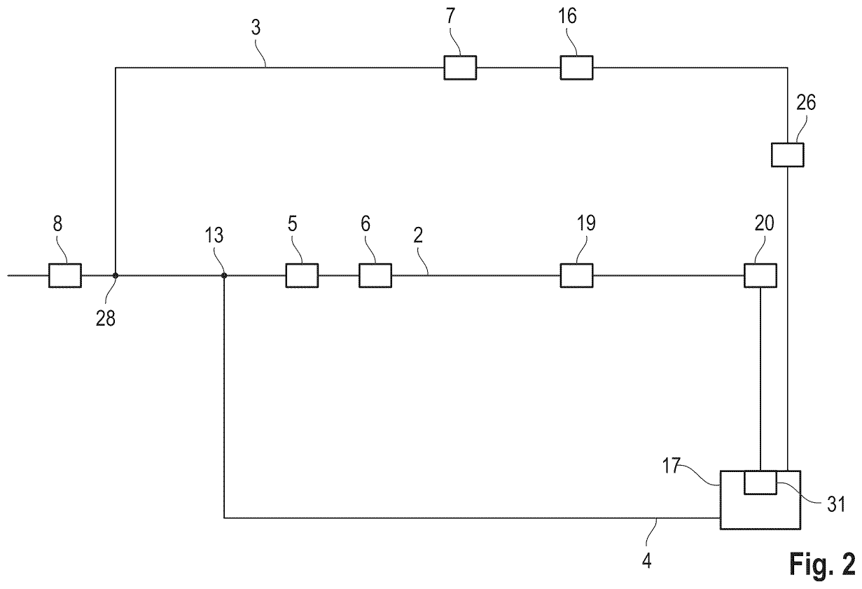

FIG. 2 shows an arrangement corresponding to FIG. 1 and further developed. Here, in addition to FIG. 1, a turbocharger 5 is arranged between the first junction 28 and the throttle valve 6. The first junction 28 is located in the local vicinity of the intake side of the turbocharger 5. The first junction 26 may also be connected to the housing of the turbocharger 5 so that the connection to the air intake line 2 is made through and/or in the housing of the turbocharger 5. This allows for the combustion engine 1 to be operated in a charged and an uncharged state. In both states, it is therefore possible to diagnose whether the crankcase ventilation line 4 and the crankcase aeration line 3 are in a proper or improper state.

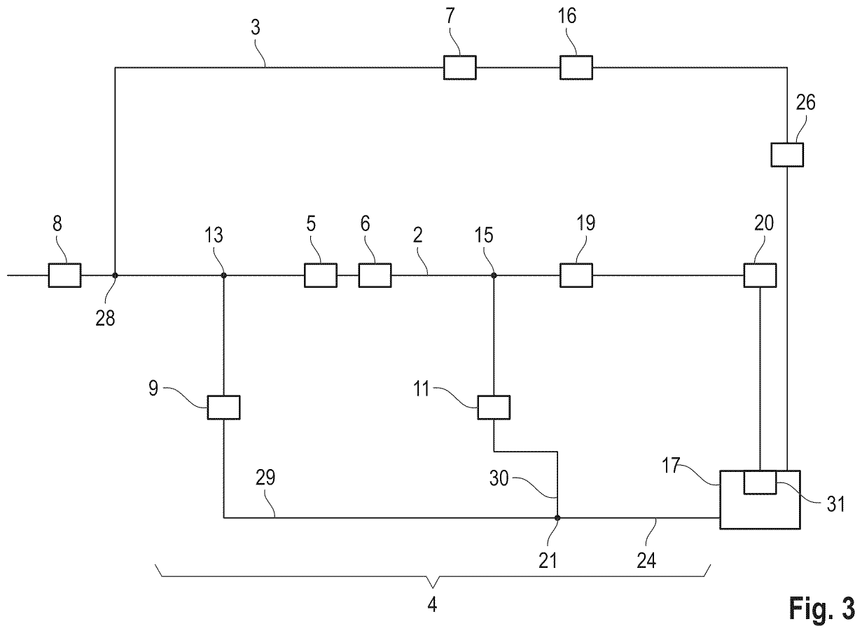

FIG. 3 shows an arrangement corresponding to FIG. 2 and further developed. Here, in addition to FIG. 2, the crankcase ventilation line 4 with the first junction 13 and a second junction 15, i.e., a total of two junctions, to the air intake line 2 is shown distinctly. Here, the crankcase ventilation line 4 formed of a section 24 as well as the first line 29 and the second line 30. The crankcase ventilation line 4 therefore branches at the crankcase ventilation line branching 21 into a first line 29 and into a second line 30. It is provided that at least one turbocharger 5 and at least one throttle valve 6 are located between the junctions 13, 15 of the crankcase ventilation line 4 that branches into the first line 29 and the second line 30 at the air intake line 2. Furthermore, it is provided that the third junction 15 of the crankcase ventilation line 4 at the air intake line 2 is located downstream of the throttle valve 6 and upstream of the air intake line branching 20. Furthermore, between the crankcase ventilation line branching 21 and the junctions of the crankcase ventilation line 13, 15 at the air intake line, at least one backflow prevention device 9, 11 per line is arranged in the first line 29 and in the second line 30.

This makes it possible to diagnose the breach of the integrity of the backflow prevention devices 9, 11 both in suction mode and in charged operation. A differentiated diagnosis of the individual backflow prevention devices 9, 11 is possible. Furthermore, a diagnosis of the junctions 13, 15 of the crankcase ventilation line 4 is possible.

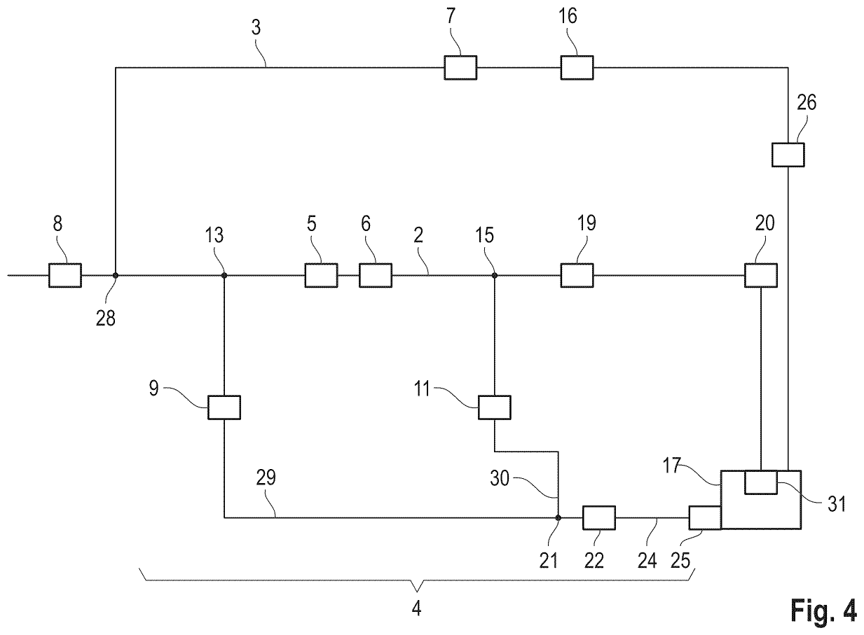

FIG. 4 shows an arrangement corresponding to FIG. 3 and further developed. Here, in addition to FIG. 3, a pressure control unit 22 is arranged between crankcase ventilation line branching 21 and the crankcase 17. Here, the crankcase ventilation line 4 formed of a section 24 as well as the first line 29 and the second line 30. Between the pressure control unit 22 and the crankcase 17, an oil separator 25 is arranged at regular intervals. The pressure control unit 22 can be used to specifically set a pressure in the crankcase 17 and in the crankcase ventilation line 4. In this way, a reliable diagnosis of the backflow prevention devices 9, 11 located in the first line 29 and in the second line 30 can be carried out in the charged and uncharged state. In other words, a proper or improper state can be detected. The pressure control unit 22 makes it possible to assign corresponding vacuums in the crankcase 17 to different operating modes and thus to the crankcase ventilation line 4, so that a differentiated diagnosis of the crankcase ventilation line 4 and the backflow prevention devices 9, 11 therein, as well as the first line 29 and the second line 30, to the air intake line 2 is made possible. This way, the integrity of the crankcase ventilation line 4 can be checked.

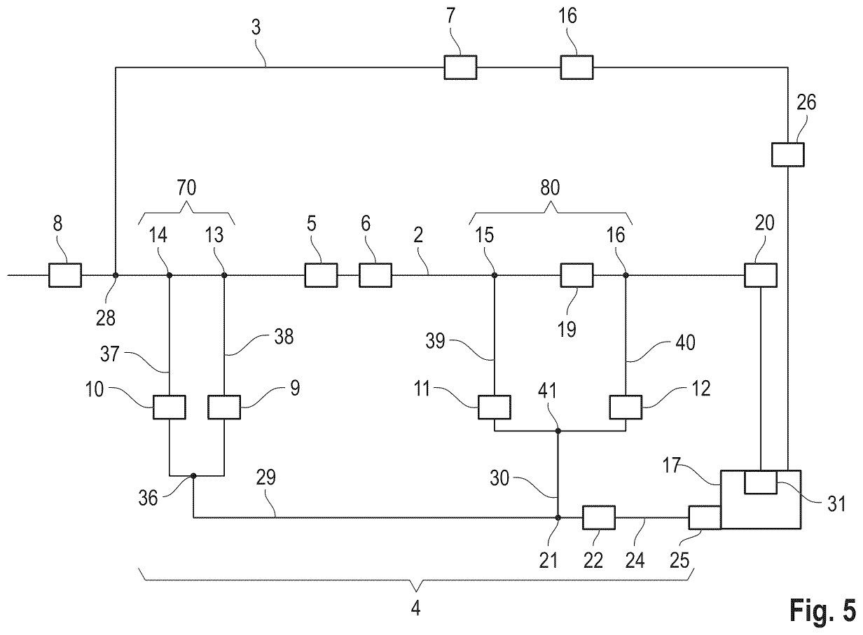

FIG. 5 shows an arrangement corresponding to FIG. 4 and further developed. Here, the crankcase ventilation line 4 formed of the section 24, the first line 29, the second line 30, a third line 37, a fourth line 38, a fifth line 39 and a sixth line 40.

In this arrangement, the first junction 70 is formed by a first junction 14 and a third junction 34. Functionally, it corresponds to the first junction 13 from, for example, FIG. 3 or FIG. 4.

In this arrangement, the second junction 80 is formed by a second junction 16 and a fourth junction 35. Functionally, the second junction 80 corresponds to the second junction 15 from, for example, FIG. 3 or FIG. 4.

In the arrangement shown in FIG. 5, the first line 29 is divided into a third line 37 and a fourth line 38 at a branch junction 36. In the third line 37, a third backflow prevention device 10 is arranged. The third line 37 is connected to the air intake line 2 between the turbocharger 5 and the crankcase aeration line connection 28 at the first junction 14. In the fourth line 38, a sixth backflow prevention device 32 is arranged. The fourth line 38 is connected to the air intake line 2 between turbocharger 5 and crankcase aeration line connection 28 at the third junction 34.

In the arrangement shown in FIG. 5, the second line 30 is divided into a fifth line 39 and a sixth line 40 at a branch junction 41. In the fifth line 39, a seventh backflow prevention device 39 is arranged. The fifth line 39 is connected to the air intake line 2 between throttle valve 6 and air intake line branching 20 at the fourth junction 35. In the sixth line 40, a fifth backflow prevention device 12 is arranged. The sixth line 40 is connected to the air intake line 2 between the throttle valve 6 and the air intake line branching 20 at the second junction 16.

The backflow prevention devices 10, 12, 32, 33 are spaced from the respective junctions 14, 16, 34, 35.

Furthermore, it is provided that the pressure control unit 22 comprises an actuation function and that the pressure control unit 22 is connected to a computer unit for the specification of a pressure to be set by the computer unit. This makes it possible to specify a pressure so that, in different operating modes, different partial arrangements of the crankcase ventilation system 23, in other words the crankcase aeration line 3 and the crankcase ventilation line 4 and the devices comprising each of them, can be diagnosed for a breach of integrity by specifying different pressures. The maximum possible vacuum in the crankcase 17 and thus also in the crankcase ventilation line 4 can be in a specified range of preferably 5 hPa to 300 hPa, especially preferably 15 hPa to 200 hPa and even more preferably 30 hPa to 150 hPa below the respective atmospheric pressure.

It is an advantage that the pressure specified by the computer unit is a function of an operating point. This is particularly advantageous, as it allows for the corresponding pressure specifications to be quickly determined in a targeted manner, for example via a stored catalog. In an example, instead of using a catalog, the specified pressure on the basis of the operating point can be determined with the computer unit using a calculation model.

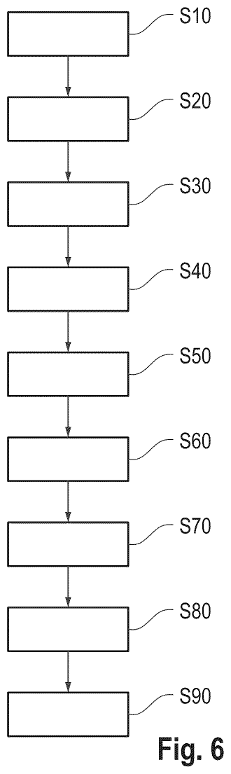

FIG. 6 shows a possible sequence of the method for diagnosing the integrity of the crankcase ventilation system 23. It is provided that the diagnosis of the breach of integrity includes the following steps: detecting an operating mode in step S10; detecting a signal from the sensor unit 18 in step S20; determining a measured value wₛ based on the signal from the sensor unit 18 in step S30; determining a reference value wᵥ in step S40; determining a difference Dₛ₋ᵥ between the measured value ws and the reference value wᵥ in step S50; determining a permissible deviation D_{z} in step S60; comparing the difference Ds-v with the permissible deviation D_{z} in step S70; determining a state based on the comparison in step S80; and triggering at least one action according to the state detected in step S90.

These steps S10 to S90 can also be carried out by the skilled person in a sequence of steps that deviate from the previous description.

It is provided that the diagnostic process is carried out immediately after a release condition has been met. A release condition can be, for example, a specified time after engine start and/or a driven distance and/or an exceeded engine speed.

In an example, it is provided that the detection of an operating mode and the acquisition of a signal from the sensor unit 18 takes place in temporal proximity. This can trigger an action during the operation of the vehicle, preferably in the temporal proximity of the detection of the operating mode. Here, temporal proximity is understood to be a period of no more than one minute, preferably no more than 15 seconds, further preferably no more than 5 seconds. This allows for the improper state to be detected as quickly as possible. In this way, the computing load available for the computing unit can be equalized.

In an example, it is provided that both the reference value wᵥ corresponding to the operating mode and the detected signal from the sensor unit 18 corresponding to the operating mode are provided with a marking corresponding to a temporal sequence. Both the reference value and the signal from the sensor unit are stored in a memory. A diagnosis is carried out at intervals by comparing the measured value of the signal from the sensor unit wₛ stored in the memory and the reference value wᵥ stored in the memory. The method also provides that only those measured values of the signal from the sensor unit wₛ and those reference values wᵥ are used for comparison, the time marking of which correspond to or lie within a specified time interval. As a result of the diagnosis, an action is triggered if the corresponding result is available. Due to the time-delayed diagnosis means that the computing power of the computer unit can be reduced. The diagnosis can also be carried out at a time when the performance of the computer unit is favorably available, so that no other, possibly safety-relevant, processes are hindered and/or slowed down. Likewise, a (re)evaluation of the collected/determined states can be carried out at a later date. Statistical evaluations can also be carried out. These statistical evaluations can be carried out in the vehicle and/or transmitted wirelessly and/or wired to an external evaluation unit. The results of the statistical evaluations can be used in the diagnosis and concrete assignment of a defective component.

In an example, the determined state is stored in a memory on the basis of the comparison S80, preferably in conjunction with a temporal marking. This is advantageous because it makes troubleshooting easier. This also makes it possible to transmit the collected determined states on the basis of the comparison S 80.

In the context of this disclosure, an action is, for example, an entry into a fault memory of the vehicle, the increase of a fault memory counter, an output in a form that is preferably perceptible to the driver's eyes and/or ears, an output for a person looking at the vehicle from the outside in a form preferably perceptible to their eyes and/or ears, a wireless transmission to another vehicle and/or infrastructure, preferably located in the immediate vicinity, a wireless transmission to a (computer-aided) control center or data collection device, a limitation of the operating modes of the vehicle, the limitation of the maximum torque to be delivered by the internal combustion engine, the limitation of the maximum number of engine revolutions to be supplied by the internal combustion engine, the limitation of the remaining operating time, the limitation of the remaining driving distance, failing to restart. Combinations of the above actions are possible.

In a proper state, the vehicle can be operated in an uncharged state. Examples of arrangements that allow for an uncharged state are listed in FIG. 1, FIG. 2, FIG. 3, FIG. 4, and FIG. 5.

In a proper state, the vehicle can be operated in a charged state. Examples of arrangements that allow for a charged state are listed in FIG. 2, FIG. 3, FIG. 4, and FIG. 5.

In an uncharged proper state, backflow prevention devices 11, 12, 35 are open, and backflow prevention devices 9, 10, 32 are closed.

In a charged proper state, backflow prevention devices 9, 10, 32 are open and backflow prevention devices 11, 12, 35 are closed.

The integrity of the crankcase ventilation system 23 is diagnosed by comparing the difference D_{S-V} with the permissible deviation D_{Z}. If, on the basis of determining a state on the basis of the comparison in step S80, the comparison is as expected and proper, then there is no breach of the crankcase ventilation system 23. This applies to the uncharged state and to the charged state.

If there is an improper state, a pressure that does not meet expectations arises in the air intake line 2 and thus in the crankcase aeration line 3. This changed pressure is detected by the sensor unit 18. Thus, a difference Dₛ₋ᵥ is determined, which results in an improper state when compared with the permissible deviation D_{z} in step S80.

An improper state of the backflow prevention devices 9, 10, 11, 12, 32, 35 can be regarded as a stuck or jammed backflow prevention device 9, 10, 11, 12, 32, 35. The backflow prevention 9, 10, 11, 12, 32, 35 then remains in an improper state.

Therefore, in an uncharged state with a proper first backflow prevention device 26, the improper state of at least one backflow prevention device 11, 12, 35 can be diagnosed in a closed state. In other words, at least one backflow prevention device 11, 12, 35 does not remain properly in a closed state.

Therefore, in an uncharged operation with a proper first backflow prevention device 26, the improper state of at least one backflow prevention device 9, 10, 32 can be diagnosed in an open state. In other words, at least one backflow prevention device 9, 10, 32 does not remain properly in an open state.

In a charged state with a proper first backflow prevention device 26, the improper state of at least one backflow prevention device 9, 10, 32 can therefore be diagnosed in a closed state. In other words, at least one backflow prevention device 9, 10, 32 does not remain properly in a closed state.

In a charged state with a proper first backflow prevention device 26, the improper state of at least one backflow prevention device 11, 12, 35 can therefore be detected in an open state. In other words, at least one backflow prevention device 11, 12, 35 does not remain properly in an open state.

In an uncharged or charged state with a proper first backflow prevention device 26, leakage of the crankcase ventilation line 4 and/or an improper connection of at least one junction 13, 15, 70, 80 may be diagnosed. In this context, a small leakage has a lesser effect than a large leakage on the measured value of the signal from the sensor unit wₛ. This will also change the difference Dₛ₋ᵥ accordingly. The same applies to the junctions 13, 15, 70, 80 of the crankcase ventilation line 4 to the air intake line 2. The more junctions 13, 15, 70, 80 are not proper, the greater the effect on the measured value of the signal from the sensor unit wₛ and thus on the difference Dₛ₋ᵥ.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An internal combustion engine with a crankcase ventilation system, comprising:
a crankcase;
an air intake line that comprises a throttle valve and an air filter;
a crankcase ventilation line to vent the crankcase, the crankcase ventilation line being arranged at a first junction downstream of the air filter of the air intake line;
a crankcase aeration line to flush the crankcase; and
a sensor arranged in the crankcase aeration line and downstream of a first flow control device and upstream of a first backflow prevention device,
wherein the first junction is located downstream at a distance from a crankcase aeration line connection at the air intake line so that a malfunction of the crankcase ventilation system is detected by the sensor.

2. The internal combustion engine according to claim 1, wherein a turbocharger is arranged downstream of the first junction and upstream of the throttle valve.

3. The internal combustion engine according to claim 2, wherein the turbocharger and the throttle valve are arranged between the first junction and a second junction, and wherein the second junction is located at the air intake line.

4. The internal combustion engine according to claim 3, wherein a backflow prevention device is arranged upstream of the respective junctions of the crankcase ventilation line at the intake line.

5. The internal combustion engine according to claim 3, wherein the crankcase ventilation line comprises a crankcase ventilation line branching and a pressure control unit, wherein the pressure control unit is located upstream of the crankcase ventilation line branching.

6. The internal combustion engine according to claim 5, wherein a volume flow from the crankcase into the intake line is set by the pressure control unit such that a specified vacuum in the crankcase is achieved in the best possible way.

7. The internal combustion engine according to claim 5, wherein the pressure control unit comprises an active actuator function and the pressure control unit is connected to a computer unit for specifying a pressure to be set.

8. The internal combustion engine according to claim 7, wherein the pressure specified by the computer unit is a function of the operating point.

9. A method of operating an internal combustion engine according to claim 1, the method comprising:
detecting an operating mode;
detecting a signal from the sensor unit;
determining a measured value wₛ based on the signal from the sensor unit;
determining a reference value wᵥ;
determining a difference Dₛ₋ᵥ between the measured value wₛ and the reference value wᵥ;
determining a permissible deviation D_{z};
comparing the difference Dₛ₋ᵥ with the permissible deviation D_{z};
determining a state on the basis of the comparison; and
triggering at least one action according to the determined state.

10. A motor vehicle comprising an internal combustion engine according to claim 1.
